(19) United States
(12) Patent Application Publication
(10) Pub. No.: US 2013/0106887 A1
(43) Pub. Date: May 2, 2013

(54) TEXTURE GENERATION USING A TRANSFORMATION MATRIX

(71) Applicant: Christopher Tremblay, Sunyvale, CA (US)

(72) Inventor: Christopher Tremblay, Sunyvale, CA (US)

(21) Appl. No.: 13/285,602

(22) Filed: Oct. 31, 2011

(51) Int. Cl. G09G 5/00

(52) U.S. Cl. 345/582

(57) ABSTRACT

A method of generating a texture object comprises, with a processor, generating a data set that defines a texture, dividing the texture into a number of texture sections comprising a number of texture vertices, generating a data set that defines an object, dividing the object into a number of object sections comprising a number of object vertices, generating a transformation matrix that defines the mathematical relationship between the texture vertices and their corresponding object vertices, and creating a data set that defines the texture object using the transformation matrix.

### BACKGROUND

As computing devices have developed, they have become capable of displaying complex objects. To aid in the rapid analysis and display of these complex objects, processors have been developed called graphics processing units (GPUs). GPUs use circuitry designed to rapidly manipulate and alter memory which accelerates the building of images created from complex objects. A GPU's highly parallel structure makes it more efficient than a standard central processing unit (CPU) to process the large amounts of data inherent in processing complex objects.

A GPU applies a texture, or electronic image, to an object to create a texture object; for example, applying a map of the world onto a spherical object to create a globe. This is performed by dividing both the object and the texture, respectively, into a number of sections. Each section contains a number of vertices defined by a two-dimensional coordinate system. Both sets of vertex coordinates are then sent to the GPU to be combined into a single set of texture object vertices.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of a system for pixel-dependent rendering, according to one example of principles described herein.

FIG. 2 is a flowchart showing a method for using pixel-dependent rendering, according to one example of principles described herein.

FIG. 3 is a flowchart showing a method for using pixel-dependent rendering, according to another example of principles described herein.

Throughout the drawings, identical reference numbers designate similar, but not necessarily identical, elements.

### DETAILED DESCRIPTION

While the circuitry of a GPU makes the process of applying a texture to an object more simple, the process still burdens the CPU's computing bandwidth as two sets of vertices are sent to the GPU to be processed. Each time a texture is to be projected onto an object it is divided into a number of texture sections that include a number of texture vertices, each vertex having a coordinate identifier. These sections are, for example, triangular in shape. The object onto which the texture is to be projected is also divided into a number of object sections. Similarly, each object section has a number of object vertices with each vertex having a coordinate identifier. Thus, each texture object vertex has two coordinates, a texture vertex coordinate and an object vertex coordinate. In this example, a texture vertex coordinate is projected onto a corresponding object vertex coordinate that has the same spatial relationship to other sections of their type.

The texture object is rendered by sending corresponding texture vertex coordinates and object vertex coordinates to the GPU and combining the corresponding texture vertex coordinates and object vertex coordinates into a single texture object vertex coordinate. The texture object is a projection of the texture onto the object. This process is computationally expensive because the GPU processes two data inputs for every one data output.

In light of these and other issues, the present specification discloses a method and a system for increasing efficiency in creating a texture object. In particular, the present specification discloses a method that uses a transformation matrix and the object vertex coordinates to project the texture onto the object. In this method, the texture vertex coordinate is not sent to the GPU for processing, and, instead the transformation matrix and the object vertex coordinates are utilized in creating a texture object. This decreases processing time, decreases processing bandwidth usage, and increases processing speed to improve the overall efficiency of texture object rendering. Consequently, more computing space is available to perform other operations and a texture object is quickly obtained. A system carrying out this method is also disclosed.

According to an example of the disclosure, the method begins by generating two different data sets; one that describes a texture which will be projected, and one that describes an object on which the texture will be projected. Next the object data set and the texture data set are divided into sections that are made up of a number of vertices, each vertex having coordinate identifiers. In this example, each texture section has a corresponding object section in which each texture section has the same spatial relationship to other texture sections as its corresponding object section has to other object sections.

After the different sections have been generated, a transformation matrix is created which mathematically defines the relationship between the texture vertex coordinates and the object vertex coordinates. This transformation matrix and the object vertex coordinates are then sent to the electronic device's GPU to calculate the texture vertex coordinate to be projected on a corresponding object vertex coordinate. The transformation matrix and the object vertex coordinates, and not the texture vertex coordinates are sent to the GPU. The GPU calculates the texture vertex coordinates using the transformation matrix and the object vertex coordinates. This reduces computing bandwidth usage because one set of coordinates is sent to the GPU along with the transformation matrix rather than both the object vertex coordinates and the texture vertex coordinates.

The present specification also discloses a system for carrying out the generation of a texture object using a transformation matrix. An example of the system includes a processor that generates an object and a texture, and divides the object and texture, respectively, into a number of sections. The processor also generates a transformation matrix that defines the mathematical relationship between the texture vertex coordinates and the object vertex coordinates. In this example, the system also includes a graphics processor programmed to project the texture onto the object by calculating the corresponding texture vertex coordinate given the transformation matrix and the object vertex coordinate.

As used in the present specification and in the appended claims, the term “texture” refers to a two-dimensional image that is projected onto an object, defined by points of color, or pixels organized in a matrix. The pixels, when viewed together, create a displayable image on a display device.

Additionally, as used in the present specification and in the appended claims, the term “texture coordinate” refers to the location of a vertex of a texture division. According to an example, each vertex of a texture division has a corresponding vertex in an object division.

Similarly, as used in the present specification and in the appended claims, the term “object coordinate” refers to the location of a vertex of an object division. According to an example, each vertex of an object division has a corresponding vertex in a texture division.

Still further, as used in the present specification and in the appended claims, the term “shader” refers to hardware or a combination of hardware and software that calculates how an individual element will be rendered. For example, a shader calculates the texture vertex coordinate based on the transformation matrix and the object vertex coordinate.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with the example is included in at least that one example, but not necessarily in other examples. The various instances of the phrase “in one example” or similar phrases in various places in the specification are not necessarily all referring to the same example.

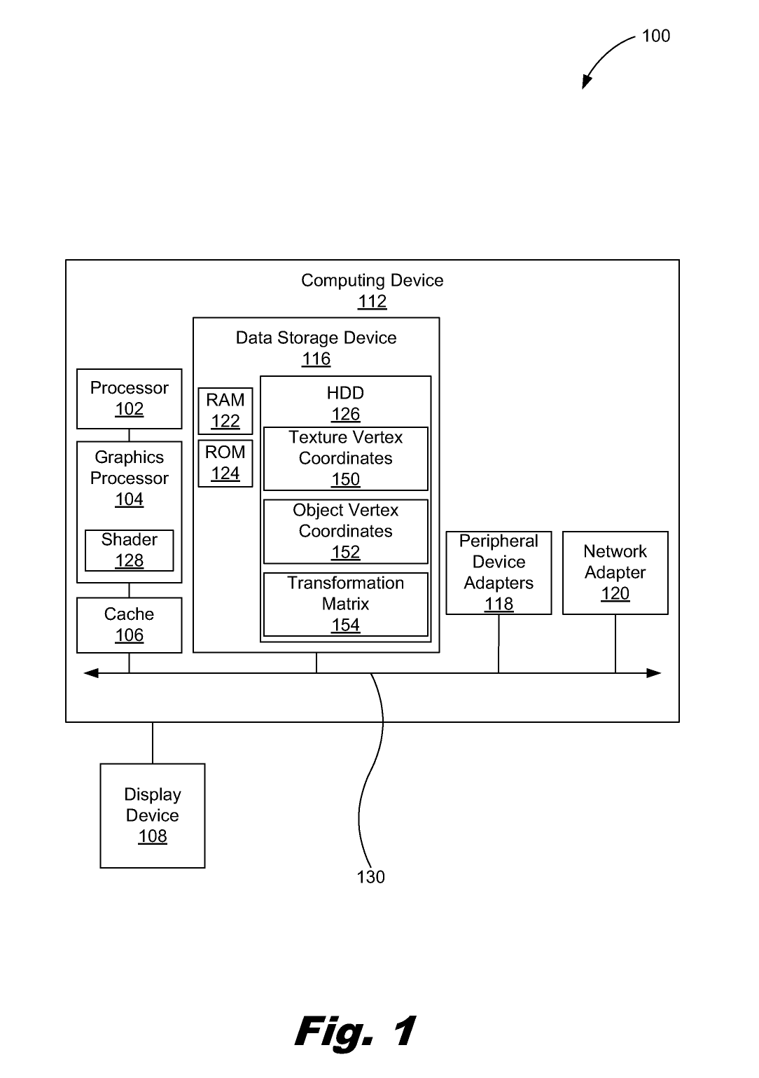

Referring now to the drawings, FIG. 1 is a diagram of a system for implementing pixel-dependent rendering (100). The system may include a processor (102) communicatively coupled to a computing device (112). Examples of an computing device (112) include, but are not limited to desktop computers, laptop computers, smart phones, personal digital assistants (PDAs), and personal computing devices. Through the processor (102), a texture is created. A texture is a rasterized image defined by pixels projected onto an object.

The processor (102) similarly creates an object onto which the texture will be projected. The processor (102) then divides the object and the texture respectively into a number of sections, each having a number of vertices that are defined by coordinate identifiers. The processor (102) stores the texture vertex coordinates (150) and object vertex coordinates (152) in, for example, the data storage device (116). In another example, the processor (102) stores the texture vertex coordinates (150) and object vertex coordinates (152) in the cache (106). Each texture vertex coordinate has a corresponding object vertex coordinate.

In addition, a transformation matrix (154) is created by the processor (102) that represents the mathematical relationship between the texture vertex coordinates (150) and the object vertex coordinates (152). Because the texture vertex coordinates (150) can be calculated from the transformation matrix (154) and the object vertex coordinates (152), the texture vertex coordinates (150) are not sent to the graphics processor (104) to be rendered. Instead, the transformation matrix (154) and the object vertex coordinates (152) are sent to the graphics processor (104).

According to an example, the processor (102) sends the transformation matrix (154) and the object vertex coordinates (152) to a cache (106) communicatively coupled to both the processor (102) and the graphics processor (104). With the information stored in the cache (106), any subsequent generation of the texture object can call the transformation matrix (154) and object vertex coordinates (152) from the cache (106) and perform the conversion.

Accordingly, the system (100) may also include a cache (106) which stores the transformation matrix (154) and the object vertex coordinates (152). According to an example of the system (100), once a texture object has been rendered, the processor (102) may provide space within the cache (106). Doing so clears processing space for future objects to be rendered. In one example, the processor (102) erases the transformation matrix (154) and the object vertex coordinates (152) from the cache (106). In another example, the processor (102) waits until the cache (106) is full before erasing it. In yet another example, the processor (102) writes over the data stored in the cache (106) as more data is stored to the cache (106).

The system (100) may also include a graphics processor (104) that is communicatively coupled to the processor (102) and the data storage device (116). In this example, the graphics processor (104) uses the transformation matrix (154) and the object vertex coordinates (152) to project the texture onto the object. This is performed by calculating the texture vertex coordinates (150) based on the transformation matrix (154) and object vertex coordinates (152). According to an example of the system (100), a shader (128) within the GPU performs this conversion. By using the transformation matrix (154) and the object vertex coordinates (152) to calculate the texture vertex coordinates (150), graphics processing bandwidth is efficiently used. Efficient use of the graphics processing bandwidth returns a texture object quickly, and frees the graphics processor (104) to perform other operations.

Once the texture vertex coordinates (150) have been calculated, the graphics processor (104) may also render the texture object into a rasterized object that can be viewed and displayed on the display device (108). A rasterized object is one that is defined by a grid of colored pixels.

Accordingly, the system (100) may also include a display device (108) that is communicatively coupled to the processor (102), the graphics processor (104), and the cache (106). In this example, once a texture object has been rendered, the processor (102) then transmits the rasterized texture object to the display device (108). The display device (108) is any electronic display device that is capable of displaying a rasterized object. Examples of a display device (108) include, but are not limited to, computer screens, personal computing device screens, a touch sensitive screen, a liquid crystal display (LCD), a plasma display, and a flat panel display. In one example, the system (100) displays the rasterized object on the display device (108) via a computer program such as, for example, an internet webpage or a computer-aided-drafting (CAD) program.

In the present example, for the purposes of simplicity in illustration, the computing device (112), graphics processor (104), cache (106), and display device (108) are communicatively coupled via bus (130). However, the principles set forth in the present specification extend equally to any alternative configuration in which a number of these elements are combined in a number of configurations. As such, examples within the scope of the principles of the present specification include examples in which the computing device (112), graphics processor (104), cache (106), and display device (108) are implemented by the same computing device. Other examples of an alternative configuration include examples in which the computing device (112), graphics processor (104), cache (106), and display device (108) are separate computing devices communicatively coupled to each other through a network or other communication paths. Still other examples of an alternative configuration include examples in which the functionality of the computing device (112) is implemented by multiple interconnected computers, for example, a server in a data center and a user's client machine. Still other examples of alternative configurations of the elements of FIG. 1 include examples in which a number of the computing device (112), graphics processor (104), cache (106), and display device (108) communicate directly through a bus without intermediary network devices.

To achieve its desired functionality, the computing device (112) includes various hardware components. Among these hardware components may be a processor (102), a graphics processor (104), a data storage device (116), peripheral device adapters (118), and a network adapter (120). These hardware components may be interconnected through the use of a number of busses and/or network connections. In one example, the processor (102), graphics processor (104), data storage device (116), peripheral device adapters (118), and a network adapter (120) may be communicatively coupled via bus (130).

The processor (102) and graphics processor (104) may include the hardware architecture for retrieving executable code from the data storage device (116) and executing the executable code. The executable code may, when executed by the processor (102) and graphics processor (104), cause the processor (102) and graphics processor (104) to implement at least the functionality of pixel-dependent rendering according to the methods of the present specification described below. In the course of executing code, the processor (102) and graphics processor (104) may receive input from and provide output to a number of the remaining hardware units.

The data storage device (116) may include various types of memory modules, including volatile and nonvolatile memory. For example, the data storage device (116) of the present example includes Random Access Memory (RAM) (122), Read Only Memory (ROM) (124), and Hard Disk Drive (HDD) memory (126). Many other types of memory are available in the art, and the present specification contemplates the use of many varying type(s) of memory in the data storage device (116) as may suit a particular application of the principles described herein. In certain examples, different types of memory in the data storage device (116) may be used for different data storage needs. For example, in certain examples the processor (102) and graphics processor (104) may boot from Read Only Memory (ROM) (124), maintain nonvolatile storage in the Hard Disk Drive (HDD) memory (126), and execute program code stored in Random Access Memory (RAM) (122).

Generally, the data storage device (116) may comprise a computer readable storage medium. For example, the data storage device (116) may be, but not limited to, an electronic, magnetic, optical, electromagnetic, infrared, or semiconductor system, apparatus, or device, or any suitable combination of the foregoing. More specific examples of the computer readable storage medium may include, for example, the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The hardware adapters (118, 120) in the computing device (112) enable the processors (102, 104) to interface with various other hardware elements, external and internal to the computing device (112). For example, peripheral device adapters (118) may provide an interface to input/output devices, such as, for example, output device (124), to create a user interface and/or access external sources of memory storage. Peripheral device adapters (118) may also create an interface between the processor (102) and graphics processor (104) and a display device (108) or other media output device. A network adapter (120) may additionally provide an interface to a network, thereby enabling the transmission of data to and receipt of data from other devices communicatively coupled within the network.

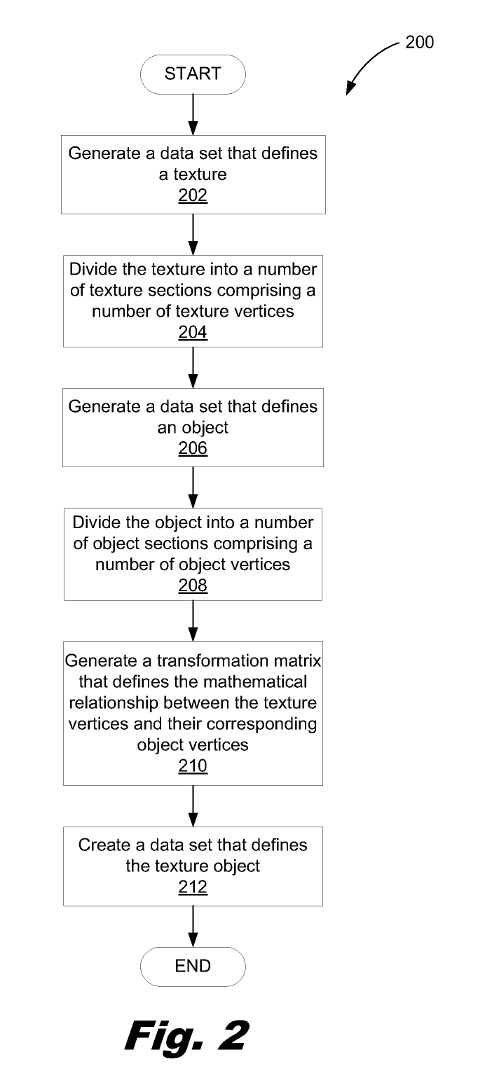

FIG. 2 is a flowchart showing a method for implementing pixel-dependent rendering (200), according to one example of principles described herein. The method (200) includes, with a processor, generating a data set that defines a texture that will be projected onto an object (block 202). The texture, as described above, is a rasterized image defined by a grid of colored pixels. Next, the texture is divided up into a number of texture sections (block 204) with each texture section having a number of texture vertices. Each texture vertex has coordinates that identify their position in the texture. For example, a texture may be defined in an x-y coordinate plane from 0 to 1 in both directions with the texture vertices being defined by a pair of numerical coordinates indicating their distance from the x axis and the y axis respectively. According to an example of the method (200), the texture sections are made up of uniformly shaped sections; for example, triangular geometries. These smaller texture sections use less processing resources, and, thus, increase the efficiency of the process and free up the processor (FIG. 1, 102) and graphics processor (FIG. 1, 104) to perform other operations.

For similar reasons, the object is similarly generated (block 206) and divided into object sections (block 208). Each object section will have a number of vertices whose position is defined by a coordinate identifier. According to an example of the method (200) each object section has a corresponding texture section such that an object section has the same spatial relationship to other object sections as does its corresponding texture section to other texture sections. For example, a particular object section, A, is bordered by object sections B, C, and D. The corresponding texture section A is likewise bordered by texture sections B, C, and D. In this example, the number of object vertices of an object section will match the number of texture vertices of a texture section.

A transformation matrix (154) is then generated which defines the mathematical relationship between the texture vertex coordinates (150) and the object vertex coordinates (152) (block 210). In one example, this relationship is linear. This relationship can be defined mathematically by the equation Mx=t, where M is the transformation matrix (154), x is the object vertex coordinate, and t is the texture vertex coordinate. In one example, the transformation matrix (M) is a 3×3 matrix. Because processing the transformation matrix (154) utilizes less computational bandwidth than does the texture vertex coordinates (150) pertaining to an entire texture, a texture object may be generated quicker. The graphics processor (FIG. 1, 104) is available to perform other operations when the transformation matrix (154) is processed in lieu of the texture vertex coordinate data set. Thus, the overall efficiency of the texture object generation process is increased.

Once the transformation matrix (154) has been generated, the object vertex coordinates (152) and the transformation matrix (154) are sent to the graphics processor (FIG. 1, 104) to generate a texture object (block 212). At block 212, the graphics processor generates a texture object, which is defined as an overlay of the texture to the object. According to an example, this may be done by a shader in the graphics processor (FIG. 1, 104).

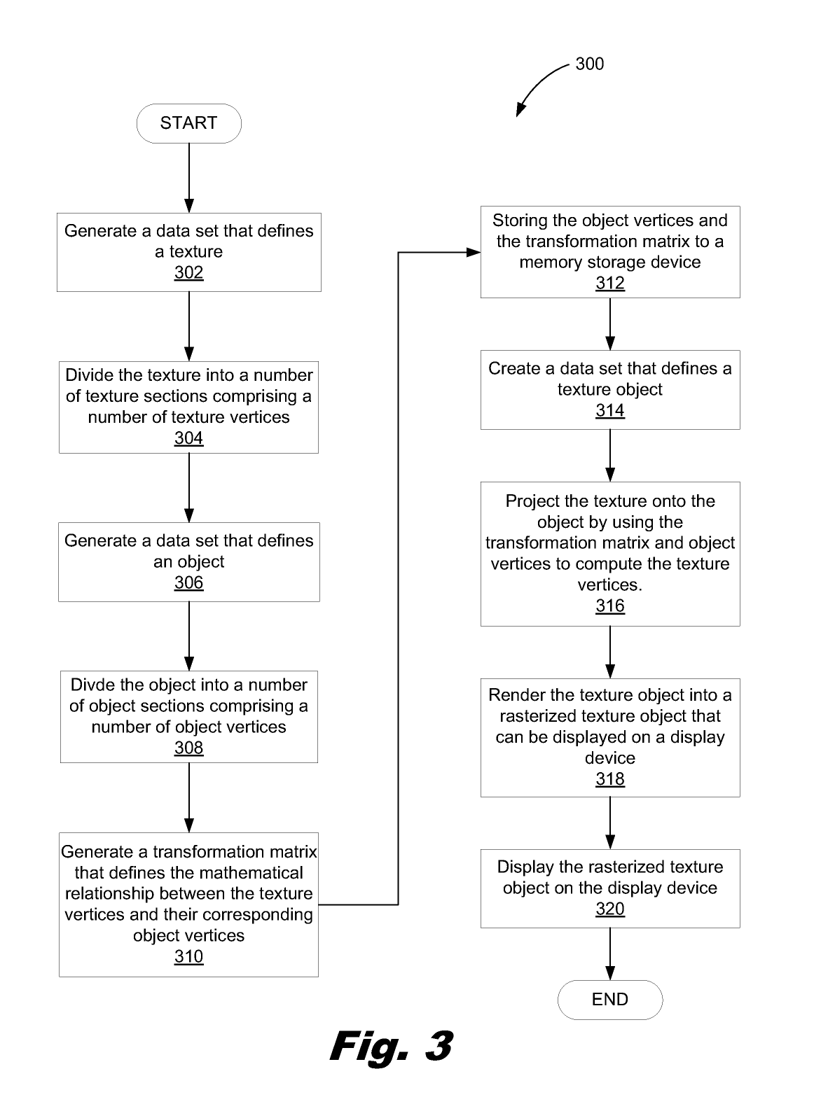

FIG. 3 is a flowchart showing a method for implementing pixel-dependent rendering (300), according to another example of principles described herein. The method (300) includes, with a processor, generating a data set that defines a texture that will be projected onto an object (block 302). The texture, as described above, is a rasterized image defined by a grid of colored pixels. The texture is divided up into a number of texture sections (block 304) with each texture section having a number of texture vertices. Each texture vertex has coordinates that identify their position in the texture. For example, a texture may be defined in an x-y coordinate plane from 0 to 1 in both directions with the texture vertices being defined by a pair of numerical coordinates indicating their distance from the x axis and the y axis respectively. According to an example of the method (300), the texture sections are made up of uniformly shaped sections; for example, triangular geometries. These smaller texture sections utilize less processing resources than the entire texture. This increases the efficiency of the process and frees up the processor (FIG. 1, 102) and graphics processor (FIG. 1, 104) to perform other operations.

For similar reasons, the object is similarly generated (block 306) and divided into object sections (block 308). Each object section will have a number of vertices whose position is defined by a coordinate identifier. According to an example of the method (300) each object section has a corresponding texture section such that an object section has the same spatial relationship to other object sections as does its corresponding texture section has to the other texture specifications. For example, a particular object section, A, is bordered by object sections B, C, and D. The corresponding texture section A is likewise bordered by texture sections B, C, and D. In this example, the number of object vertices of an object section will match the number of texture vertices of a texture section.

A transformation matrix (154) is then generated which defines the mathematical relationship between the texture vertex coordinates (150) and the object vertex coordinates (152) (block 310). In one example, this relationship is linear. This relationship can be defined mathematically using the equation Mx=t, where M is the transformation matrix (154), x is the object vertex coordinate, and t is the texture vertex coordinate. In one example, the transformation matrix (M) is a 3×3 matrix. Because processing the transformation matrix (154) utilizes less computational bandwidth than does the texture vertex coordinates (150) pertaining to an entire texture, a texture object is generated quicker and the graphics processor (FIG. 1, 104) is available to perform other operations when the transformation matrix (154) is processed in lieu of the texture vertex coordinate data set. Thus, the overall efficiency of the texture object generation process is increased.

According to an example of the method (300), the transformation matrix (154) and the object vertex coordinates (152) are then stored to the cache (FIG. 1, 106) (block 312) that is communicatively coupled to the processor (FIG. 1, 102) and the graphics processor (FIG. 1, 104). Thus, calculation of the transformation matrix (154) for each instance that a particular texture is applied to a particular object is not performed because the transformation matrix (154) and the object vertex coordinates (152) are stored in the cache (FIG. 1, 106). This frees up computational bandwidth and processor resources. As a result the time to generate a texture object is reduced.

Once the transformation matrix (154) has been calculated, the object vertex coordinates (152) and the transformation matrix (154) are sent to the graphics processor (FIG. 1, 104) to generate a texture object (block 314). At block 314, the graphics processor (FIG. 1, 104) generates a texture object that is defined as an overlay of the texture to the object. According to an example this may be done by a shader (FIG. 1, 128) in the graphics processor (FIG. 1, 104).

In this example, the shader (FIG. 1, 128) projects the texture onto the object using the transformation matrix (154) and the object vertex coordinates (152) (block 316). Given that the transformation matrix (154) defines the mathematical relationship between the texture vertex coordinates (150) and the object vertex coordinates (152), the transformation matrix (154), in conjunction with the object vertex coordinates (152) can be used to determine what texture vertex coordinates (150) apply. As described above, a transformation matrix (154) is less expensive computationally than a data set of coordinates. Therefore, as a result of sending the transformation matrix (154) and one set of coordinates, the object vertex coordinates (152), a texture object is created more efficiently than by sending both the object vertex coordinates (152) and the texture vertex coordinates (150).

An example of the method (300) may also include rendering the texture object into a rasterized texture object that can be displayed on the display device (FIG. 1, 108) (block 318). Once the object has been rendered, the computing device (FIG. 1, 112) may display the rasterized object on the display device (FIG. 1, 108) (block 320). Examples of display devices include, but are not limited to computer screens, personal computing device screens, a touch sensitive screen, a liquid crystal display (LCD), a plasma display, and a flat panel display. In one example, the system (100) displays the rasterized object on the display device (FIG. 1, 108) via a computer program such as, for example, an internet webpage or a, computer-aided-drafting (CAD) program.

The methods described above may be accomplished in conjunction with a computer program product comprising a computer readable medium having computer usable program code embodied therewith that, when executed by a processor, performs the above processes and methods. Specifically, the computer usable program code, when executed by a processor, generates a data set that defines a texture; divides the texture into a number of texture sections comprising a number of texture vertices; generates a data set that defines an object; divides the object into a number of object sections comprising a number of object vertices; generates a transformation matrix (154) that defines the mathematical relationship between the texture vertices and their corresponding object vertices; and creates a data set that defines the texture object.

The preceding description has illustrated a method and system for pixel-dependent rendering. The method generates an object and texture and then divides each of them respectively into a number of sections. Next, a transformation matrix is calculated which defines the mathematical relationship between corresponding texture sections and object sections. This transformation matrix along with the object vertex coordinates are sent to a graphics processor which converts them into a texture object. The current method and system reduce the number of computations a graphics processor has to perform by sending one set of coordinates along with a transformation matrix which allows the calculation of the texture vertex coordinates. The reduction in computation, frees up computing bandwidth, and increases the efficiency of rendering texture objects.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method of generating a texture object, the method comprising:
with a processor, generating a data set that defines a texture;
dividing the texture into a number of texture sections comprising a number of texture vertices;
generating a data set that defines an object;
dividing the object into a number of object sections comprising a number of object vertices;
generating a transformation matrix that defines the mathematical relationship between the texture vertices and their corresponding object vertices; and
creating a data set that defines the texture object using the transformation matrix.

2. The method of claim 1, in which:
the object sections and the texture sections contain the same number of vertices; and
the texture vertices have corresponding object vertices to which they will project onto.

3. The method of claim 1, in which creating a data set that defines the texture object further comprises projecting the texture onto the object by using the transformation matrix and object vertices to compute the texture vertices.

4. The method of claim 1, further comprising:
rendering the texture object into a rasterized texture object that can be displayed on a display device; and
displaying the rasterized texture object on the display device.

5. The method of claim 1, in which the object sections and the texture sections comprise similarly shaped geometries.

6. The method of claim 4, in which the object sections and the texture sections comprise triangular geometries.

7. The method of claim 1, in which the mathematical relationship between the texture vertices and the object vertices is linear.

8. The method of claim 1, further comprising storing the object vertices and the transformation matrix to a cache.

9. A system to render an object comprising:
a processor to:
generate a data set that defines a texture;
divide the texture into a number of texture sections comprising a number of texture vertices;
generate a data set that defines an object;
divide the object into a number of object sections comprising a number of object vertices; and
generate a transformation matrix that defines the mathematical relationship between the texture vertices and their corresponding object vertices; and
a graphics processor to create a data set that defines the texture object using the transformation matrix.

10. The system of claim 8, in which the graphics processor further projects the texture onto the object using the transformation matrix and object vertices to compute the texture vertices.

11. The system of claim 8, in which the graphics processor further renders the texture object into a rasterized texture object that can be displayed on a display device.

12. The system of claim 8, further comprising a cache that receives and stores the matrix and object vertices.

13. The system of claim 11, further comprising a display device that displays the rasterized texture object.

14. A computer program product for generating a texture object, the computer program product comprising:
a computer readable storage medium comprising computer usable program code embodied therewith, the computer usable program code comprising:
computer usable program code that, when executed by a processor, generates a data set that defines a texture;
computer usable program code that, when executed by a processor, divides the texture into a number of texture sections comprising a number of texture vertices;
computer usable program code that, when executed by a processor, generates a data set that defines an object;
computer usable program code that, when executed by a processor, divides the object into a number of object sections comprising a number of object vertices;
computer usable program code that, when executed by a processor, generates a transformation matrix that defines the mathematical relationship between the texture vertices and their corresponding object vertices; and
computer usable program code that, when executed by a processor, creates a data set that defines the texture object by projecting the texture onto the object by using the transformation matrix and object vertices to compute the texture vertices.

15. The computer program product of claim 13, further comprising:
computer usable program code that, when executed by a processor, renders the texture object into a rasterized texture object that can be displayed on a display device;
computer usable program code that, when executed by a processor, displays the rasterized texture object on the display device; and
computer usable program code that, when executed by a processor, stores the object vertices and the matrix to a memory storage device.
